(19) United States
(12) Patent Application Publication
(10) Pub. No.: US 2025/0225729 A1
(43) Pub. Date: Jul. 10, 2025

(54) THREE-DIMENSIONAL (3D) RECONSTRUCTION METHOD AND APPARATUS FOR MULTI-TILLERING CROP PLANT, DEVICE, AND MEDIUM

(71) Applicant: Information Technology Research Center, Beijing Academy of Agriculture and Forestry Sciences, BEIJING (CN)

(72) Inventors: Xinyu GUO, BEIJING (CN); Weiliang WEN, BEIJING (CN); Wenxuan GU, BEIJING (CN); Sheng WU, BEIJING (CN)

(21) Appl. No.: 19/006,961

(22) Filed: Dec. 31, 2024

(30) Foreign Application Priority Data
Jan. 4, 2024 (CN) 202410014854.9

(51) Int. Cl. G06T 17/20; G06T 19/20

(52) U.S. Cl. CPC G06T 17/20; G06T 19/20; G06T 2210/56; G06T 2219/2021

(57) ABSTRACT

This application relates to the technical field of three-dimensional (3D) reconstruction, and in particular to a 3D reconstruction method and apparatus for a multi-tillering crop plant, a device, and a medium. The first reconstruction result of each single stem is obtained through the single-stem growth characteristic information and the 3D leaf template database, such that the 3D reconstruction result obtained based on the first reconstruction result exhibits satisfactory consistency with the measured data in crop phenotype. By optimizing the second reconstruction result, the optimized 3D reconstruction result exhibits satisfactory consistency with the measured data in vertical spatial distribution. This application can realize the 3D reconstruction for the multi-tillering crop plant of the complex morphology and structure, and provide a strong support for research of the multi-tillering crop plant.

### CROSS REFERENCE TO RELATED APPLICATION

This patent application claims the benefit and priority of Chinese Patent Application No. 2024100148549, filed with the China National Intellectual Property Administration on Jan. 4, 2024, the disclosure of which is incorporated by reference herein in its entirety as part of the present application.

### TECHNICAL FIELD

The present disclosure relates to the technical field of three-dimensional (3D) reconstruction, and in particular to a 3D reconstruction method and apparatus for a multi-tillering crop plant, a device, and a medium.

### BACKGROUND

3D plant reconstruction has wide application prospects in many fields of crop research. For example, the 3D reconstructed model can be utilized to extract the morphological and structural phenotypes of the plants, or analyze the radiation-use efficiency of crops from different plant architectures.

The 3D plant reconstruction in the prior art mainly includes: A point cloud of the plant is acquired through a multi-view image or a light detection and ranging (LiDAR). According to the point cloud of the plant, phenotypic analysis and reconstruction are performed with a deep learning method.

However, there are at least the following problems in the prior art: Due to a complex structure of the multi-tillering crop plant, the 3D reconstruction method for the multi-tillering crop plant in the prior art requires dispersed tillers. For the plant with complex morphology and structure, numerous tillers, rich details, cross-obscuration, and the like, the 3D reconstruction result is undesirable.

### SUMMARY

The present disclosure provides a 3D reconstruction method and apparatus for a multi-tillering crop plant, a device, and a medium, to solve the defect of the undesirable 3D reconstruction result for the structurally complex crop plant in the prior art, and realize 3D reconstruction of the multi-tillering crop plant.

The present disclosure provides a 3D reconstruction method for a multi-tillering crop plant, including following steps:
acquiring point cloud data of a to-be-reconstructed plant;
determining single-stem growth characteristic information of the to-be-reconstructed plant according to the point cloud data;
acquiring a first reconstruction result of each single stem of the to-be-reconstructed plant according to the single-stem growth characteristic information and a 3D leaf template database, the 3D leaf template database including multiple leaf mesh models;
determining a second reconstruction result of the to-be-reconstructed plant according to the first reconstruction result of the single stem; and
optimizing an azimuth of each leaf in the second reconstruction result to obtain a 3D reconstruction result of the to-be-reconstructed plant.

According to the 3D reconstruction method for a multi-tillering crop plant provided by the present disclosure, the 3D leaf template database is obtained as follows:
acquiring single-stem point cloud data of the to-be-reconstructed plant;
acquiring a leaf point cloud segmented result according to the single-stem point cloud data of the to-be-reconstructed plant;
acquiring leaf mesh models according to the leaf point cloud segmented result; and
obtaining the 3D leaf template database according to multiple different leaf mesh models.

According to the 3D reconstruction method for a multi-tillering crop plant provided by the present disclosure, the single-stem growth characteristic information includes a number of single stems, angles of the single stems, lengths of the single stems, and growth points of the single stems, and the determining single-stem growth characteristic information of the to-be-reconstructed plant according to the point cloud data includes:
performing organ clustering on the point cloud data to determine the number of single stems, the angles of the single stems, and the lengths of the single stems of the to-be-reconstructed plant;
intercepting the point cloud data to obtain a plant base point cloud; and
determining the growth points of the single stems of the to-be-reconstructed plant according to the plant base point cloud and the number of single stems.

According to the 3D reconstruction method for a multi-tillering crop plant provided by the present disclosure, the determining the growth points of the single stems of the to-be-reconstructed plant according to the plant base point cloud and the number of single stems includes:
clustering the plant base point cloud with a K-means algorithm to obtain central points; and
determining the growth points of the single stems of the to-be-reconstructed plant according to a spatial distribution of the central points.

According to the 3D reconstruction method for a multi-tillering crop plant provided by the present disclosure, the acquiring a first reconstruction result of each single stem of the to-be-reconstructed plant according to the single-stem growth characteristic information and a 3D leaf template database includes:
constricting a number of leaves on the single stem according to a leaf number model, and constricting a phenotypic parameter of each leaf on the single stem according to a leaf shape variation model, to obtain generation parameters of the leaf;
determining, according to the generation parameters of the leaf, a leaf mesh model corresponding to the leaf from the 3D leaf template database; and
obtaining the first reconstruction result of the single stem according to the leaf mesh model corresponding to the leaf and the single-stem growth characteristic information.

According to the 3D reconstruction method for a multi-tillering crop plant provided by the present disclosure, the optimizing an azimuth of each leaf in the second reconstruction result to obtain a 3D reconstruction result of the to-be-reconstructed plant includes:
determining a to-be-optimized single stem queue according to the second reconstruction result; and
traversing each single stem in the single stem queue, and optimizing an azimuth of each leaf on the single stem, such that a chamfer distance between an optimized second reconstruction result and the point cloud data is minimum to obtain the 3D reconstruction result of the to-be-reconstructed plant.

The present disclosure provides a 3D reconstruction apparatus for a multi-tillering crop plant, including:
a data acquisition module configured to acquire point cloud data of a to-be-reconstructed plant;
a characteristic information module configured to determine single-stem growth characteristic information of the to-be-reconstructed plant according to the point cloud data;
a first reconstruction module configured to acquire a first reconstruction result of each single stem of the to-be-reconstructed plant according to the single-stem growth characteristic information and a 3D leaf template database, the 3D leaf template database including multiple leaf mesh models;
a second reconstruction module configured to determine a second reconstruction result of the to-be-reconstructed plant according to the first reconstruction result of the single stem; and
an optimization module configured to optimize an azimuth of each leaf in the second reconstruction result to obtain a 3D reconstruction result of the to-be-reconstructed plant.

The present disclosure further provides an electronic device, including a memory, a processor, and a computer program stored in the memory and executable on the processor, where when the program is executed by the processor, the 3D reconstruction method for a multi-tillering crop plant is implemented.

The present disclosure further provides a non-transient computer-readable storage medium, storing a computer program, where when the computer program is executed by a processor, the 3D reconstruction method for a multi-tillering crop plant is implemented.

The present disclosure further provides a computer program product, including a computer program, where when the computer program is executed by a processor, the 3D reconstruction method for a multi-tillering crop plant is implemented.

According to the 3D reconstruction method and apparatus for a multi-tillering crop plant, the device, and the medium provided by the present disclosure, the first reconstruction result of each single stem is obtained through the single-stem growth characteristic information and the 3D leaf template database, such that the 3D reconstruction result obtained based on the first reconstruction result exhibits satisfactory consistency with the measured data in crop phenotype. By optimizing the second reconstruction result, the optimized 3D reconstruction result exhibits satisfactory consistency with the measured data in vertical spatial distribution. The present disclosure can realize the 3D reconstruction for the multi-tillering crop plant of the complex morphology and structure, and provide a strong support for research of the multi-tillering crop plant.

### BRIEF DESCRIPTION OF THE DRAWINGS

To describe the technical solutions in the present disclosure or in the prior art more clearly, the accompanying drawings required for describing embodiments or the prior art will be briefly described below. Apparently, the accompanying drawings in the following description show some embodiments of the present disclosure, and a person of ordinary skill in the art may still derive other drawings from these accompanying drawings without creative efforts.

FIG. 1 is a schematic flowchart of a 3D reconstruction method for a multi-tillering crop plant according to the present disclosure;

FIG. 2 is a schematic structural view of a 3D reconstruction apparatus for a multi-tillering crop plant according to the present disclosure; and

FIG. 3 is a structural schematic view of an electronic device according to the present disclosure.

### DETAILED DESCRIPTION OF THE EMBODIMENTS

To make the objectives, technical solutions and advantages of the present disclosure clearer, the following clearly and completely describes the technical solutions in the present disclosure with reference to the accompanying drawings in the present disclosure. Apparently, the described embodiments are some but not all of the embodiments of the present disclosure. All other embodiments obtained by a person of ordinary skill in the art based on the embodiments of the present disclosure without creative efforts shall fall within the protection scope of the present disclosure.

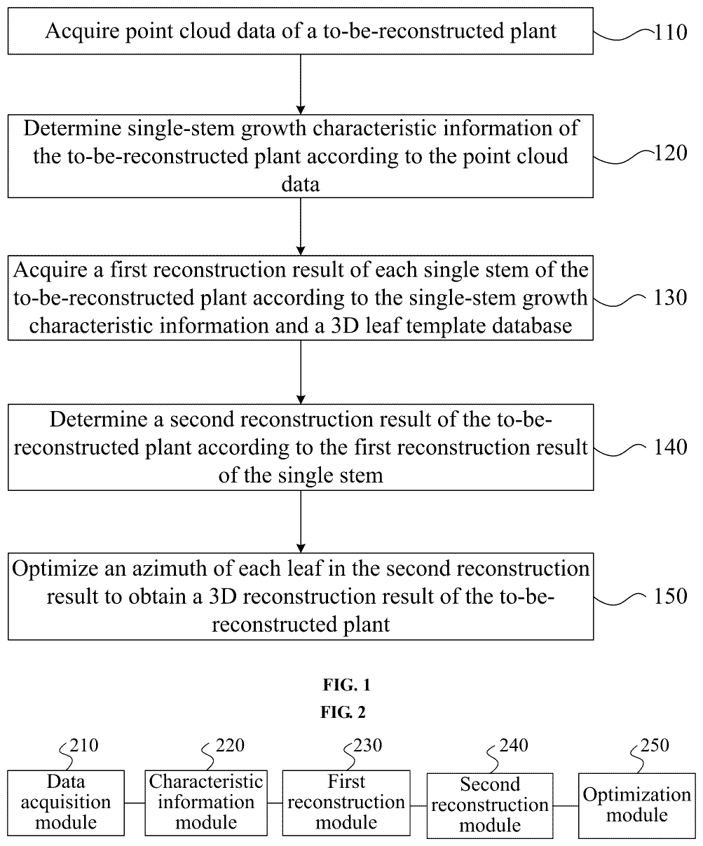

With reference to FIG. 1 to FIG. 3, a 3D reconstruction method and apparatus for a multi-tillering crop plant, a device, and a medium provided by the present disclosure will be described below.

FIG. 1 is a schematic flowchart of a 3D reconstruction method for a multi-tillering crop plant according to the present disclosure. As shown in FIG. 1, the 3D reconstruction method for a multi-tillering crop plant includes Step 110 to Step 150. Specifically:

Step 110: Point cloud data of a to-be-reconstructed plant is acquired.

Step 120: Single-stem growth characteristic information of the to-be-reconstructed plant is determined according to the point cloud data.

Step 130: A first reconstruction result of each single stem of the to-be-reconstructed plant is acquired according to the single-stem growth characteristic information and a 3D leaf template database, the 3D leaf template database including multiple leaf mesh models.

Step 140: A second reconstruction result of the to-be-reconstructed plant is determined according to the first reconstruction result of the single stem.

Step 150: An azimuth of each leaf in the second reconstruction result is optimized to obtain a 3D reconstruction result of the to-be-reconstructed plant.

In the embodiment of the present disclosure, the point cloud data in Step 110 may be obtained by reconstructing multi-view image data of the to-be-reconstructed plant with a multi-view image based 3D reconstruction method, and may also be obtained by scanning the to-be-reconstructed plant with a LiDAR. Through preprocessing such as denoising, scaling and segmentation on an original point cloud obtained by an active sensing device, the point cloud data may be obtained in the embodiment of the present disclosure. This removes invalid data to improve the 3D reconstruction accuracy.

In the embodiment of the present disclosure, the single-stem growth characteristic information in Step 120 includes a number of single stems, angles of the single stems, lengths of the single stems, and growth points of the single stems. The single-stem growth characteristic information may be analyzed with a biological method, and may also be obtained by processing the point cloud data with a statistical method or a machine learning method, or obtained by manually labeling a physical object of the to-be-reconstructed plant. In other embodiments of the present disclosure, the single-stem growth characteristic information may be any index information for indicating growth states of the single stems, such as diameters of the single stems, and curvatures of the single stems.

In the embodiment of the present disclosure, in Step 130, the first reconstruction result of the single stem is obtained by splicing multiple leaf mesh models in the 3D leaf template database to the stem according to a preset rule. It is to be understood that the leaf mesh model and the to-be-reconstructed plant belong to a same crop. Compared with the prior art in which the 3D reconstruction is performed directly according to the point cloud, splicing the leaf mesh models to the stem in the embodiment of the present disclosure can restore details of the leaf better, and thus the 3D reconstruction result obtained based on the first reconstruction result exhibits satisfactory consistency with measured data in crop phenotype.

In the embodiment of the present disclosure, in Step 150, the azimuth of the leaf is an azimuth of the leaf mesh model spliced to the stem relative to the single stem. Since the phenotype of the leaf is similar to the measured data, optimizing the azimuth can directly optimize a vertical spatial distribution of the 3D reconstruction result, such that the 3D reconstruction result exhibits satisfactory consistency with the measured data in vertical spatial distribution. In the embodiment of the present disclosure, by optimizing the azimuth of the leaf on the single stem, a better reconstruction result is achieved in case of numerous tillers, and cross-obscuration between stems and leaves.

According to the 3D reconstruction method for a multi-tillering crop plant provided by the present disclosure, the first reconstruction result of each single stem is obtained through the single-stem growth characteristic information and the 3D leaf template database, such that the 3D reconstruction result obtained based on the first reconstruction result exhibits satisfactory consistency with the measured data in crop phenotype. By optimizing the second reconstruction result, the optimized 3D reconstruction result exhibits satisfactory consistency with the measured data in vertical spatial distribution. The present disclosure can realize the 3D reconstruction for the multi-tillering crop plant of the complex morphology and structure, and provide a strong support for research of the multi-tillering crop plant.

In the embodiment of the present disclosure, the 3D leaf template database is obtained as follows:

Single-stem point cloud data of the to-be-reconstructed plant is acquired.

A leaf point cloud segmented result is acquired according to the single-stem point cloud data of the to-be-reconstructed plant.

Leaf mesh models are acquired according to the leaf point cloud segmented result.

The 3D leaf template database is obtained according to multiple different leaf mesh models.

The step that single-stem point cloud data of the to-be-reconstructed plant is acquired specifically includes: The single stems of the to-be-reconstructed crop whose organs are intact and little crossed are selected, and sampled destructively. The single-stem point cloud data of the to-be-reconstructed plant is acquired with the active sensing device (such as the LiDAR or the camera).

The step that a leaf point cloud segmented result is acquired according to the single-stem point cloud data of the to-be-reconstructed plant specifically includes: According to the single-stem point cloud data, through a plant stem and leaf segmentation method based on deep learning such as PointNet++, stem-leaf-ear segmentation of the single stems can be realized. For a leaf point cloud, since leaves are not overlapped with each other, segmentation from a leaf population to the single leaves can be realized by clustering. It is to be understood that the leaf point cloud segmented result may also be obtained with other machine learning methods or a statistical method. Since the point cloud data is only intended for the single stem, the segmentation method according to the prior art can achieve a desirable effect.

The step that leaf mesh models are acquired according to the leaf point cloud segmented result may include: For each segmented leaf point cloud, a skeleton of the point cloud is extracted. The leaf point cloud is equidistantly sliced according to the skeleton. Edges of each slicing line are taken as two edge points of a present segment. All left edge points are connected. All right edge points are connected. Skeleton points are extracted. Thus, all vertices on a 3D mesh model of the leaf are obtained. The vertices are partitioned to form triangular meshes to obtain the leaf mesh model. It is to be understood that the leaf reconstruction method is not limited to the method provided in the embodiment of the present disclosure. Since the point cloud data is only intended for the single stem, the stem and leaf segmented result obtained based on the prior art can achieve a desirable leaf reconstruction effect.

The step that the 3D leaf template database is obtained according to multiple different leaf mesh models specifically includes: A characteristic label, such as a variety, a growth period, a sequence, a length, a width, an area, and an inclination angle of the leaf, is assigned to the leaf mesh model, thereby obtaining the 3D leaf template database.

It is to be understood that in the embodiment of the present disclosure, the single stems of the plant are sampled destructively only when the 3D leaf template database is established, and can be reused in 3D reconstruction to realize non-contact 3D reconstruction of the plant. On the other hand, according to the 3D leaf template database in the embodiment of the present disclosure, multiple leaf mesh models can be obtained according to the single stems. This reduces the number of destructive sampling times, and lowers the construction cost of the 3D leaf template database.

In the embodiment of the present disclosure, Step 120 includes:

Organ clustering is performed on the point cloud data to determine the number of single stems, the angles of the single stems, and the lengths of the single stems of the to-be-reconstructed plant.

The point cloud data is intercepted to obtain a plant base point cloud.

The growth points of the single stems of the to-be-reconstructed plant are determined according to the plant base point cloud and the number of single stems.

It is to be understood that although the multi-tillering crop plant has the complex morphology and structure, the machine learning algorithm can still achieve a desirable effect in a case where only the number of single stems, the angles of the single stems, and the lengths of the single stems of the to-be-reconstructed plant are determined. That is, in the step that organ clustering is performed on the point cloud data to determine the number of single stems, the angles of the single stems, and the lengths of the single stems of the to-be-reconstructed plant, the clustering algorithm can obtain the single-stem growth characteristic information desirably, including the number of single stems, the angles of the single stems, and the lengths of the single stems.

In the embodiment of the present disclosure, the plant base point cloud may be obtained by intercepting the point cloud data by a preset distance along a normal direction of the ground from the ground.

In the embodiment of the present disclosure, through Step 120, the single-stem growth characteristic information of the to-be-reconstructed plant can be determined automatically without manual labeling. This reduces the experience dependence and the realization cost.

In the embodiment of the present disclosure, the step that the growth points of the single stems of the to-be-reconstructed plant are determined according to the plant base point cloud includes:

The plant base point cloud is clustered with a K-means algorithm to obtain central points.

The growth points of the single stems of the to-be-reconstructed plant are determined according to a spatial distribution of the central points.

Specifically, the plant base point cloud is clustered with the K-means algorithm or other clustering algorithms to obtain m central points. According to a spatial distribution of the m central points and the number of single stems, n growth points of the single stems are obtained, n being the number of single stems. For example, the m points may be re-clustered into n clusters, and central points of the n clusters are calculated to taken as initial growth points. The number of central points in the K-means algorithm may also be directly the same as the number of single stems. It is to be understood that the initial growth points may also be calculated with other statistical methods or other machine learning methods.

In the embodiment of the present disclosure, with the K-means algorithm, the point cloud data is segmented into subsets having similar features. It can be considered that each subset of the point cloud data is located on the same stem. Through secondary clustering, the number of subsets of the point cloud data is the same as the number of single stems, thereby obtaining the initial growth points of the single stems.

In the embodiment of the present disclosure, Step 130 includes:

A number of leaves on the single stem is constricted according to a leaf number model, and a phenotypic parameter of each leaf on the single stem is constricted according to a leaf shape variation model, to obtain generation parameters of the leaf.

According to the generation parameters of the leaf, a leaf mesh model corresponding to the leaf is determined from the 3D leaf template database.

The first reconstruction result of the single stem is obtained according to the leaf mesh model corresponding to the leaf and the single-stem growth characteristic information.

In the embodiment of the present disclosure, the leaf number model is used to describe a number of leaves on the single stem, and the leaf shape variation model is used to describe a rule of the phenotypic parameters of the leaves, such as a length variation rule, a width variation rule, an area variation rule, and an inclination angle variation rule in a vertical height direction. The leaf number model and the leaf shape variation model in the embodiment of the present disclosure may be obtained with the statistical method or the machine learning method according to labeled data in the 3D leaf template database, and may also be analyzed with a biological method.

In the embodiment of the present disclosure, the generation parameters of the leaf may include a position, a length, a width, and an area. The step that according to the generation parameters of the leaf, a leaf mesh model corresponding to the leaf is determined from the 3D leaf template database specifically includes: A similarity function is constructed through the position, the length, the width, and the area, and the corresponding leaf mesh model is matched in the 3D leaf template database. The similarity function may be constructed with a statistical method.

In the embodiment of the present disclosure, the step that the first reconstruction result of the single stem is obtained according to the leaf mesh model corresponding to the leaf and the single-stem growth characteristic information specifically includes: The leaf mesh model corresponding to the leaf is assembled to a corresponding position of the leaf on the single stem through translation and rotation to obtain the first reconstruction result of the single stem.

In the embodiment of the present disclosure, through Step 130, the single stem is reconstructed, and the position, the length, the width, and the area of each leaf in the first reconstruction result meet the constraints. Therefore, the details of the leaf can be restored better, and the 3D reconstruction result obtained based on the first reconstruction result exhibits satisfactory consistency with the measured data in crop phenotype.

In the embodiment of the present disclosure, Step 140 specifically includes: First reconstruction results of n single stems obtained in Step 130 are translated to growth positions of the single stems to obtain the second reconstruction result.

In the embodiment of the present disclosure, Step 150 specifically includes:

A to-be-optimized single stem queue is determined according to the second reconstruction result.

Each single stem in the single stem queue is traversed, and an azimuth of each leaf on the single stem is optimized, such that a chamfer distance between an optimized second reconstruction result and the point cloud data is minimum to obtain the 3D reconstruction result of the to-be-reconstructed plant.

In the embodiment of the present disclosure, the step that a to-be-optimized single stem queue is determined according to the second reconstruction result may include: According to a clockwise direction, the to-be-optimized single stem queue is determined with the outer single stem for precedence. It is to be understood that tillers of the outer single stem only have a half of cross-obscuration. Hence, the optimization from the outer single stem to the inner single stem can better take the cross-obscuration of the multi-tillering crop into account.

In the embodiment of the present disclosure, the step that each single stem in the single stem queue is traversed, and an azimuth of each leaf on the single stem is optimized, such that a chamfer distance between an optimized second reconstruction result and the point cloud data is minimum to obtain the 3D reconstruction result of the to-be-reconstructed plant specifically includes:

The single stem is considered as a set of 3D phytomers. Each 3D phytomer may include one node, one internode, one sheath, and one leaf. The 3D phytomers in the single stem are traversed from top to bottom. Each leaf in the phytomer is rotated by an angle of θ counterclockwise around the stem where it is located. The θ may be multiple sets of values from 0° to 360° at a preset stride. Each rotation generates one virtual single stem. The virtual single stem is in one-to-one correspondence with the value of the θ.

The virtual single stem is used to replace the single stem in the second reconstruction result. The chamfer distance between the second reconstruction result and the point cloud data is calculated, and the virtual single stem having a minimum chamfer distance and corresponding to the value of the θ is selected to replace the single stem in the second reconstruction result.

Each single stem in the single stem queue is traversed to obtain the 3D reconstruction result of the to-be-reconstructed plant.

The chamfer distance is expressed as:

$${d}_{CD} ( P , W ) = \frac{1}{P} {\sum }_{x ϵ P} {min}_{y ϵ w} {‖ x - y ‖}_{2}^{2} + \frac{1}{W} {\sum }_{y ϵ w} {min}_{x ϵ P} {‖ y - x ‖}_{2}^{2}$$

In the foregoing equation, d_{CD} is the chamfer distance, P is the 3D point cloud data, W is the second reconstruction result after the single stem is replaced, and x and y each are a spatial coordinate.

In the embodiment of the present disclosure, through Step 150, the vertical spatial distribution of the 3D reconstruction result can be optimized directly. Through the chamfer distance provided in the embodiment of the present disclosure, the reconstruction result nearest to the point cloud data can be obtained. That is, the reconstruction result exhibits satisfactory consistency with the point cloud data. This achieves the better reconstruction effect in case of numerous tillers, and cross-obscuration between the stems and leaves.

According to the 3D reconstruction method for a multi-tillering crop plant provided by the present disclosure, the first reconstruction result of each single stem is obtained through the single-stem growth characteristic information and the 3D leaf template database, such that the 3D reconstruction result obtained based on the first reconstruction result exhibits satisfactory consistency with the measured data in crop phenotype. By optimizing the second reconstruction result, the optimized 3D reconstruction result exhibits satisfactory consistency with the measured data in vertical spatial distribution. The present disclosure can realize the 3D reconstruction for the multi-tillering crop plant of the complex morphology and structure, and provide a strong support for research of the multi-tillering crop plant.

The 3D reconstruction apparatus for a multi-tillering crop plant provided by the present disclosure will be described below. The following description on the 3D reconstruction apparatus for a multi-tillering crop plant and the above description on the 3D reconstruction method for a multi-tillering crop plant may refer to each other.

FIG. 2 is a schematic structural view of a 3D reconstruction apparatus for a multi-tillering crop plant according to the present disclosure. Referring to FIG. 2, the 3D reconstruction apparatus for a multi-tillering crop plant includes: a data acquisition module 210, a characteristic information module 220, a first reconstruction module 230, a second reconstruction module 240, and an optimization module 250.

The data acquisition module 210 is configured to acquire point cloud data of a to-be-reconstructed plant.

The characteristic information module 220 is configured to determine single-stem growth characteristic information of the to-be-reconstructed plant according to the point cloud data.

The first reconstruction module 230 is configured to acquire a first reconstruction result of each single stem of the to-be-reconstructed plant according to the single-stem growth characteristic information and a 3D leaf template database, the 3D leaf template database including multiple leaf mesh models.

The second reconstruction module 240 is configured to determine a second reconstruction result of the to-be-reconstructed plant according to the first reconstruction result of the single stem.

The optimization module 250 is configured to optimize an azimuth of each leaf in the second reconstruction result to obtain a 3D reconstruction result of the to-be-reconstructed plant.

Therefore, according to the 3D reconstruction apparatus for a multi-tillering crop plant provided by the present disclosure, the first reconstruction result of each single stem is obtained through the single-stem growth characteristic information and the 3D leaf template database, such that the 3D reconstruction result obtained based on the first reconstruction result exhibits satisfactory consistency with the measured data in crop phenotype. By optimizing the second reconstruction result, the optimized 3D reconstruction result exhibits satisfactory consistency with the measured data in vertical spatial distribution. The present disclosure can realize the 3D reconstruction for the multi-tillering crop plant of the complex morphology and structure, and provide a strong support for research of the multi-tillering crop plant.

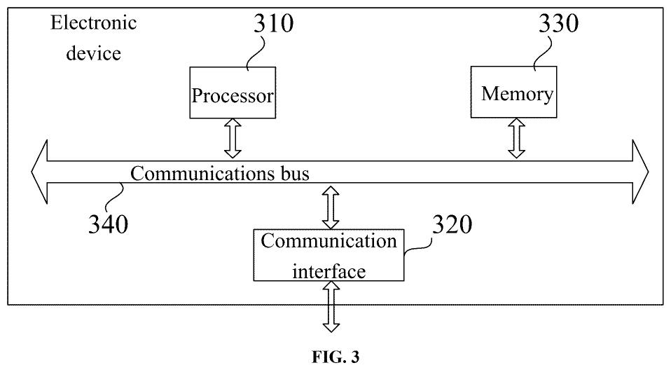

FIG. 3 illustrates a schematic view of a physical structure of an electronic device. As shown in FIG. 3, the electronic device may include: a processor 310, a communications interface 320, a memory 330, and a communication bus 340. The processor 310, the communications interface 320 and the memory 330 are in communication with one another by means of the communication bus 340. The processor 310 may be configured to invoke a logic instruction in the memory 330 to execute the 3D reconstruction method for a multi-tillering crop plant, which includes the following steps:

Point cloud data of a to-be-reconstructed plant is acquired.

Single-stem growth characteristic information of the to-be-reconstructed plant is determined according to the point cloud data.

A first reconstruction result of each single stem of the to-be-reconstructed plant is acquired according to the single-stem growth characteristic information and a 3D leaf template database, the 3D leaf template library including multiple leaf mesh models.

A second reconstruction result of the to-be-reconstructed plant is determined according to the first reconstruction result of the single stem.

An azimuth of each leaf in the second reconstruction result is optimized to obtain a 3D reconstruction result of the to-be-reconstructed plant.

Besides, the logic instruction in the memory 330 may be implemented as a software function unit and be stored in a computer-readable storage medium when sold or used as a separate product. On the basis of such understanding, the technical solutions of the present disclosure essentially or the part contributing to the prior art or part of the technical solutions may be embodied in a form of a software product. The computer software product is stored in a storage medium, and includes several instructions for enabling a computer device (which may be a personal computer, a server, a network device, etc.) to execute all or some steps of the methods described in the embodiments of the present disclosure. The foregoing storage medium includes various media capable of storing a program code, such as a USB flash disk, a mobile hard disk, a read-only memory (ROM), a random access memory (RAM), a magnetic disk, and an optical disc.

In another aspect, the present disclosure further provides a computer program product. The computer program product includes a computer program. The computer program may be stored on a non-transient computer-readable storage medium. When the computer program is executed by a processor, a computer may execute the 3D reconstruction method for a multi-tillering crop plant, which includes the following steps:

Point cloud data of a to-be-reconstructed plant is acquired.

Single-stem growth characteristic information of the to-be-reconstructed plant is determined according to the point cloud data.

A first reconstruction result of each single stem of the to-be-reconstructed plant is acquired according to the single-stem growth characteristic information and a 3D leaf template database, the 3D leaf template database including multiple leaf mesh models.

A second reconstruction result of the to-be-reconstructed plant is determined according to the first reconstruction result of the single stem.

An azimuth of each leaf in the second reconstruction result is optimized to obtain a 3D reconstruction result of the to-be-reconstructed plant.

In yet another aspect, the present disclosure further provides a non-transient computer-readable storage medium. The non-transient computer-readable storage medium stores a computer program. When the computer program is executed by a processor, the 3D reconstruction method for a multi-tillering crop plant is implemented, which includes the following steps:

Point cloud data of a to-be-reconstructed plant is acquired.

Single-stem growth characteristic information of the to-be-reconstructed plant is determined according to the point cloud data.

A first reconstruction result of each single stem of the to-be-reconstructed plant is acquired according to the single-stem growth characteristic information and a 3D leaf template database, the 3D leaf template database including multiple leaf mesh models.

A second reconstruction result of the to-be-reconstructed plant is determined according to the first reconstruction result of the single stem.

An azimuth of each leaf in the second reconstruction result is optimized to obtain a 3D reconstruction result of the to-be-reconstructed plant.

The apparatus embodiment described above is merely schematic, where the unit described as a separate component may or may not be physically separated, and a component displayed as a unit may or may not be a physical unit, that is, the component may be located at one place, or distributed on multiple network units. Some or all of the modules may be selected based on actual needs to achieve the objectives of the solutions of the embodiments. A person of ordinary skill in the art can understand and implement the embodiments without creative efforts.

Through the description of the foregoing implementations, a person skilled in the art can clearly understand that the implementations can be implemented by means of software plus a necessary universal hardware platform, or certainly, can be implemented by hardware. Based on such understanding, the foregoing technical solution which is essential or a part contributing to the prior art may be embodied in the form of a software product, the computer software product may be stored in a computer readable storage medium, such as an ROM/RAM, a magnetic disk or an optical disc, including a plurality of instructions for causing a computer device (which may be a personal computer, a server, or a network device) to perform the methods described in the examples or some parts of the examples.

Finally, it should be noted that the above examples are only intended to illustrate, but not to limit, the technical solutions of the present disclosure; although the present disclosure has been described in detail with reference to the foregoing examples, those of ordinary skill in the art should understand that: the technical solutions recorded in the foregoing examples may be still modified, or some of the technical features may be equivalently substituted; these modifications or substitutions do not cause the essence of the corresponding technical solutions to depart from the spirit and scope of the technical solutions of the examples of the present disclosure.

What is claimed is:

1. A three-dimensional (3D) reconstruction method for a multi-tillering crop plant, comprising following steps:
acquiring point cloud data of a to-be-reconstructed plant;
determining single-stem growth characteristic information of the to-be-reconstructed plant according to the point cloud data;
acquiring a first reconstruction result of each single stem of the to-be-reconstructed plant according to the single-stem growth characteristic information and a 3D leaf template database, the 3D leaf template database comprising multiple leaf mesh models;
determining a second reconstruction result of the to-be-reconstructed plant according to the first reconstruction result of the single stem; and
optimizing an azimuth of each leaf in the second reconstruction result to obtain a 3D reconstruction result of the to-be-reconstructed plant.

2. The 3D reconstruction method for a multi-tillering crop plant according to claim 1, wherein the 3D leaf template database is obtained as follows:
acquiring single-stem point cloud data of the to-be-reconstructed plant;
acquiring a leaf point cloud segmented result according to the single-stem point cloud data of the to-be-reconstructed plant;
acquiring leaf mesh models according to the leaf point cloud segmented result; and
obtaining the 3D leaf template database according to multiple different leaf mesh models.

3. The 3D reconstruction method for a multi-tillering crop plant according to claim 1, wherein the single-stem growth characteristic information comprises a number of single stems, angles of the single stems, lengths of the single stems, and growth points of the single stems, and the determining single-stem growth characteristic information of the to-be-reconstructed plant according to the point cloud data comprises:
performing organ clustering on the point cloud data to determine the number of single stems, the angles of the single stems, and the lengths of the single stems of the to-be-reconstructed plant;
intercepting the point cloud data to obtain a plant base point cloud; and
determining the growth points of the single stems of the to-be-reconstructed plant according to the plant base point cloud and the number of single stems.

4. The 3D reconstruction method for a multi-tillering crop plant according to claim 3, wherein the determining the growth points of the single stems of the to-be-reconstructed plant according to the plant base point cloud and the number of single stems comprises:
clustering the plant base point cloud with a K-means algorithm to obtain central points; and
determining the growth points of the single stems of the to-be-reconstructed plant according to a spatial distribution of the central points.

5. The 3D reconstruction method for a multi-tillering crop plant according to claim 3, wherein the acquiring a first reconstruction result of each single stem of the to-be-reconstructed plant according to the single-stem growth characteristic information and a 3D leaf template database comprises:
constricting a number of leaves on the single stem according to a leaf number model, and constricting a phenotypic parameter of each leaf on the single stem according to a leaf shape variation model, to obtain generation parameters of the leaf;
determining, according to the generation parameters of the leaf, a leaf mesh model corresponding to the leaf from the 3D leaf template database; and
obtaining the first reconstruction result of the single stem according to the leaf mesh model corresponding to the leaf and the single-stem growth characteristic information.

6. The 3D reconstruction method for a multi-tillering crop plant according to claim 5, wherein the optimizing an azimuth of each leaf in the second reconstruction result to obtain a 3D reconstruction result of the to-be-reconstructed plant comprises:
determining a to-be-optimized single stem queue according to the second reconstruction result; and
traversing each single stem in the single stem queue, and optimizing an azimuth of each leaf on the single stem, such that a chamfer distance between an optimized second reconstruction result and the point cloud data is minimum to obtain the 3D reconstruction result of the to-be-reconstructed plant.

7. A three-dimensional (3D) reconstruction apparatus for a multi-tillering crop plant, comprising:
a data acquisition module configured to acquire point cloud data of a to-be-reconstructed plant;
a characteristic information module configured to determine single-stem growth characteristic information of the to-be-reconstructed plant according to the point cloud data;
a first reconstruction module configured to acquire a first reconstruction result of each single stem of the to-be-reconstructed plant according to the single-stem growth characteristic information and a 3D leaf template database, the 3D leaf template database comprising multiple leaf mesh models;
a second reconstruction module configured to determine a second reconstruction result of the to-be-reconstructed plant according to the first reconstruction result of the single stem; and
an optimization module configured to optimize an azimuth of each leaf in the second reconstruction result to obtain a 3D reconstruction result of the to-be-reconstructed plant.

8. An electronic device, comprising a memory, a processor, and a computer program stored in the memory and executable on the processor, wherein when the program is executed by the processor, the three-dimensional (3D) reconstruction method for a multi-tillering crop plant according to claim 1 is implemented.

9. A non-transitory computer-readable storage medium, storing a computer program, wherein when the computer program is executed by a processor, the three-dimensional (3D) reconstruction method for a multi-tillering crop plant according to claim 1 is implemented.

10. The electronic device according to claim 8, wherein the 3D leaf template database is obtained as follows:
acquiring single-stem point cloud data of the to-be-reconstructed plant;
acquiring a leaf point cloud segmented result according to the single-stem point cloud data of the to-be-reconstructed plant;
acquiring leaf mesh models according to the leaf point cloud segmented result; and
obtaining the 3D leaf template database according to multiple different leaf mesh models.

11. The electronic device according to claim 8, wherein the single-stem growth characteristic information comprises a number of single stems, angles of the single stems, lengths of the single stems, and growth points of the single stems, and the determining single-stem growth characteristic information of the to-be-reconstructed plant according to the point cloud data comprises:
performing organ clustering on the point cloud data to determine the number of single stems, the angles of the single stems, and the lengths of the single stems of the to-be-reconstructed plant;
intercepting the point cloud data to obtain a plant base point cloud; and
determining the growth points of the single stems of the to-be-reconstructed plant according to the plant base point cloud and the number of single stems.

12. The electronic device according to claim 11, wherein the determining the growth points of the single stems of the to-be-reconstructed plant according to the plant base point cloud and the number of single stems comprises:
clustering the plant base point cloud with a K-means algorithm to obtain central points; and
determining the growth points of the single stems of the to-be-reconstructed plant according to a spatial distribution of the central points.

13. The electronic device according to claim 11, wherein the acquiring a first reconstruction result of each single stem of the to-be-reconstructed plant according to the single-stem growth characteristic information and a 3D leaf template database comprises:
constricting a number of leaves on the single stem according to a leaf number model, and constricting a phenotypic parameter of each leaf on the single stem according to a leaf shape variation model, to obtain generation parameters of the leaf;
determining, according to the generation parameters of the leaf, a leaf mesh model corresponding to the leaf from the 3D leaf template database; and
obtaining the first reconstruction result of the single stem according to the leaf mesh model corresponding to the leaf and the single-stem growth characteristic information.

14. The electronic device according to claim 13, wherein the optimizing an azimuth of each leaf in the second reconstruction result to obtain a 3D reconstruction result of the to-be-reconstructed plant comprises:
determining a to-be-optimized single stem queue according to the second reconstruction result; and
traversing each single stem in the single stem queue, and optimizing an azimuth of each leaf on the single stem, such that a chamfer distance between an optimized second reconstruction result and the point cloud data is minimum to obtain the 3D reconstruction result of the to-be-reconstructed plant.

15. The non-transitory computer-readable storage medium according to claim 9, wherein the 3D leaf template database is obtained as follows:
acquiring single-stem point cloud data of the to-be-reconstructed plant;
acquiring a leaf point cloud segmented result according to the single-stem point cloud data of the to-be-reconstructed plant;
acquiring leaf mesh models according to the leaf point cloud segmented result; and
obtaining the 3D leaf template database according to multiple different leaf mesh models.

16. The non-transitory computer-readable storage medium according to claim 9, wherein the single-stem growth characteristic information comprises a number of single stems, angles of the single stems, lengths of the single stems, and growth points of the single stems, and the determining single-stem growth characteristic information of the to-be-reconstructed plant according to the point cloud data comprises:
performing organ clustering on the point cloud data to determine the number of single stems, the angles of the single stems, and the lengths of the single stems of the to-be-reconstructed plant;
intercepting the point cloud data to obtain a plant base point cloud; and
determining the growth points of the single stems of the to-be-reconstructed plant according to the plant base point cloud and the number of single stems.

17. The non-transitory computer-readable storage medium according to claim 16, wherein the determining the growth points of the single stems of the to-be-reconstructed plant according to the plant base point cloud and the number of single stems comprises:
clustering the plant base point cloud with a K-means algorithm to obtain central points; and
determining the growth points of the single stems of the to-be-reconstructed plant according to a spatial distribution of the central points.

18. The non-transitory computer-readable storage medium according to claim 16, wherein the acquiring a first reconstruction result of each single stem of the to-be-reconstructed plant according to the single-stem growth characteristic information and a 3D leaf template database comprises:
constricting a number of leaves on the single stem according to a leaf number model, and constricting a phenotypic parameter of each leaf on the single stem according to a leaf shape variation model, to obtain generation parameters of the leaf;
determining, according to the generation parameters of the leaf, a leaf mesh model corresponding to the leaf from the 3D leaf template database; and
obtaining the first reconstruction result of the single stem according to the leaf mesh model corresponding to the leaf and the single-stem growth characteristic information.

19. The non-transitory computer-readable storage medium according to claim 18, wherein the optimizing an azimuth of each leaf in the second reconstruction result to obtain a 3D reconstruction result of the to-be-reconstructed plant comprises:
determining a to-be-optimized single stem queue according to the second reconstruction result; and
traversing each single stem in the single stem queue, and optimizing an azimuth of each leaf on the single stem, such that a chamfer distance between an optimized second reconstruction result and the point cloud data is minimum to obtain the 3D reconstruction result of the to-be-reconstructed plant.
